(19) United States
(12) Patent Application Publication
(10) Pub. No.: US 2025/0149891 A1
(43) Pub. Date: May 8, 2025

(54) POWER SUPPLY FOR A LOCAL CONSUMER LOAD

(71) Applicant: Essity Hygiene and Health Aktiebolag, Goteborg (SE)

(72) Inventors: Robert Kling, GÖTEBORG (SE); Jonas Kuylenstierna, GÖTEBORG 4 (SE); Gustav Danielsson, GÖTEBORG (SE); Andreas Jansson, BORLÄNGE (SE); Erik Lärfars, BORLÄNGE (SE); Rickard Hedlund, BORLÄNGE (SE)

(21) Appl. No.: 18/832,268

(22) PCT Filed: Jan. 31, 2022
(86) PCT No.: PCT/EP2022/052207

§ 371 Date: Jul. 23, 2024

(51) Int. Cl. H02J 3/28; H02J 3/38; H02J 50/00

(52) U.S. Cl. CPC H02J 3/28; H02J 3/38; H02J 50/001; H02J 2300/24

(57) ABSTRACT

A power supply unit for a local consumer load comprises an electrical power generating device (10) configured to generate power from the environment and to provide first electrical power; an electrical energy storage (20) configured to store electrical energy and to provide second electrical power; an electric buffer (30) configured to receive and to buffer said first and said second electric power, and to provide a buffer output power; and an output power regulator (40) configured to provide an output power at a nominal output voltage from said buffer output power, and to adjust said nominal output voltage based on an amount of energy stored by said electrical energy storage (20).

### CROSS REFERENCE TO RELATED APPLICATIONS

This application is a National Stage Application of PCT/EP2022/052207, filed Jan. 31, 2022, which is incorporated by reference in its entirety herein.

### TECHNICAL FIELD

The disclosure relates to power supply for a local consumer load. More specifically, the present invention relates to power supply unit that provides electric power to a local consumer load in the exemplary form of a data acquisition unit, a data collection unit, a dispenser, or the like.

### BACKGROUND

With the advent of large-scale automated data acquisition, especially in the context of the so-called Internet of things (IoT), the use and need of respective distributed data acquisition equipment becomes more and more pronounced. If sensible and high-quality data is to be collected, the data should originate from sources that are as close as possible to the event that is subject to detection. This, in turn, may require local and widely distributed data acquisition equipment in the form of a large number of individual data sensors. In combination with the distributed locations, it is clear that power supply for the devices and the involved equipment may not always be available, especially as compared to communication access as most systems employ wireless communication with ranges of substantial or oftentimes at least satisfactory extent.

While some power supplies require a connection to the mains, others may require regular recharging or replacement if the used batteries cannot be recharged. On the other hand, there are energy harvesting concepts that generate power from the environment by means of absorbing light (solar cells), electromagnetic signals, heat and temperature changes and the like. While such supply can generally suffer from predictability and regularity, the energy can be still buffered when available and provided to the load from that buffer when needed. Also, hybrid solutions exist, which, however, still suffer from reliability and efficiency issues as the actual power consumption of the in-field loads are usually difficult to predict.

There is therefore a need for improved power supply units and elements that are able to reliably feed a load with electric power independent from location, environment conditions and actual use and consumption patterns. There is specifically a need for improved power supply units for supplying power to in-field load devices in the context of IoT and other distributed data acquisition environments.

### SUMMARY

The mentioned problems and drawbacks are addressed by the subject matter of the independent claims. Further preferred embodiments are defined in the dependent claims. Specifically, the embodiments may provide substantial benefits that are described in part herein.

According to one aspect there is provided a power supply unit for a local consumer load including an electrical power generating device configured to generate power from the environment and to provide first electrical power; an electrical energy storage configured to store electrical energy and to provide second electrical power; an electric buffer configured to receive and to buffer said first and said second electric power, and to provide a buffer output power; and an output power regulator configured to provide an output power at a nominal output voltage from said buffer output power, and to adjust said nominal output voltage based on an amount of energy stored by said electrical energy storage.

According to a further aspect there is provided a load device configured to report acquired data toward a data processor, including a processing unit configured to compile a report message in relation to said acquired data, and a transmission unit configured to transmit said compiled message toward said data processor, said load device being adapted to be supplied with said output power provided by a power supply unit according to any one of the applicable other embodiments, wherein said processing unit is configured to compile said message further based on the voltage of said output power.

### BRIEF DESCRIPTION OF THE DRAWINGS

Embodiments, which are presented for better understanding the inventive concepts but which are not to be seen as limiting the invention, will now be described with reference to the figures in which:

FIGS. 1A and 1B show schematic views of a power supply unit according to an embodiment;

FIGS. 2A to 2D show schematic views of adjusting the nominal output voltage based on a stored amount of energy according to respective embodiments;

FIG. 3 shows a schematic view of a load device to be supplied by power according to an embodiment;

FIGS. 4A to 4C show schematic views of load devices in specific forms according to the respective embodiments, and

FIG. 5 shows a schematic view of a message configuration according to an embodiment.

### DETAILED DESCRIPTION

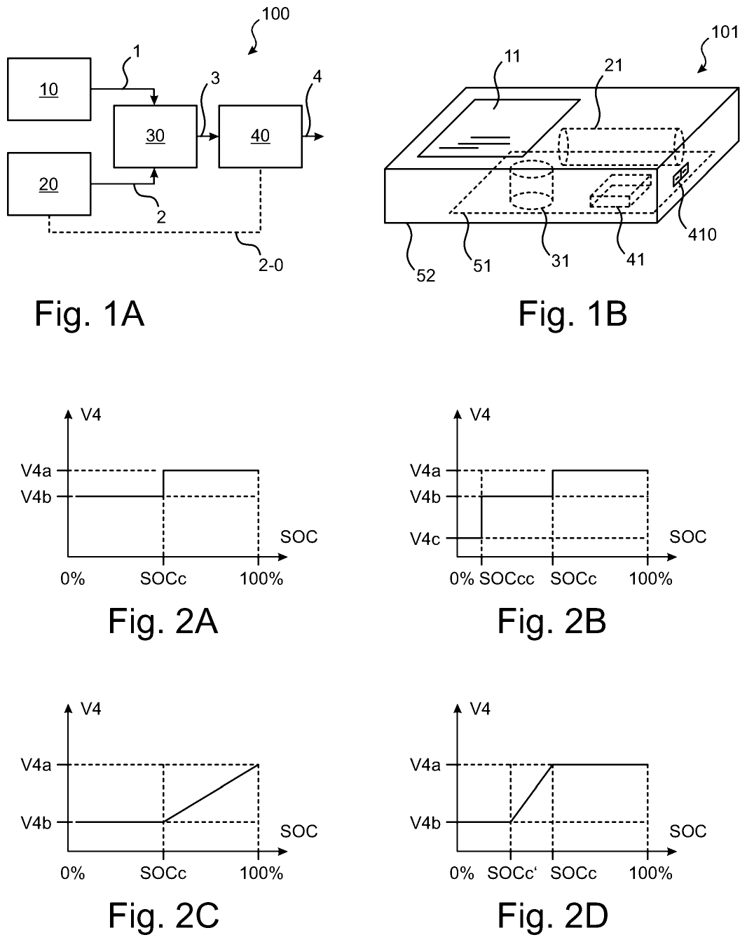

FIG. 1A shows a schematic view of the functional elements of a power supply unit according to an embodiment. Specifically, there is shown a power supply unit 100 that can provide power for a local consumer load in the exemplary form of a data acquisition unit, a data collection unit, a dispenser, or the like. In general terms, a local consumer load can be a device that is to be provided with electric power and is arranged to operate although not having access to a continuous power source such as a connection to a power line, this being direct or via a voltage converter (e.g. a switching power supply, a transformer, a power adaptor and the like).

The power supply unit 100 includes an electrical power generating device 10 that is configured to generate power from the environment and to provide first electrical power 1. This first electric power 1 can be provided with a first electric current I1 at a first electric voltage V1, the current power being the product as usual (P1=I1×V1). The electrical power generating device 10 can include any one of an energy harvesting element, a solar cell, a solar panel, a thermal energy cell, a radio wave harvester, and the like. Generally, all types of electric power generating device are considered but types that allow local energy generation with low complexity, low cost, low weight and high reliability are preferred.

The power supply unit 100 includes an electrical energy storage 20 that is configured to store electrical energy and to provide second electrical power 2. This second electric power 2 can be provided with a second electric current I2 at a second electric voltage V2, the current power being the product as usual (P2=I2×V2). The second electric voltage V2 may be also referred to as a so-called electrical energy storage voltage in conjunction with other parts of the present disclosure. The electrical energy storage 20 may include or may be formed by any one of a battery, a rechargeable battery, and a super capacitor. Generally, the electrical energy storage 20 may provide the second electric power 2 substantially independent from the environment so as to compensate for the first electric power 1 provided by the electrical power generating device 10 not being sufficient for a current demand or being not available at all. For example, the electrical power generating device 10 may be in the form of a solar cell, which will not provide the first electric power 1 in darkness or under insufficient illumination.

The power supply unit 100 further includes an electric buffer 30 that is configured to receive and to buffer said first electric power 1 and said second electric power 2, and to provide a buffer output power 3. Again, this buffer output power 3 can be provided with a third electric current I3 at a third electric voltage V3, the current power being the product as usual (P3=I3×V3). The electricity buffer 30 may include or may be formed by any one of an electrolytic capacitor, a tantalum capacitor, a high-capacity capacitor, a rechargeable battery, a super capacitor, and an ultracap. The electric buffer 30 is primarily provided for storing electric energy from collecting the first electric power 1 provided by the electrical power generating device 10. Specifically, the electrical power generating device 10 is supposed to provide the first electric power 1 whenever possible, e.g. in case of a solar cell when the illumination is sufficient. These periods of sufficient energy generation may, however, not coincide with periods or the points in time when the local consumer load requires power supply.

For providing the output power to a local consumer load, the power supply unit 100 includes an output power regulator 40 that is configured to provide the output power 4 at a nominal output voltage (V4) from said buffer output power 3. For example, the output power regulator 40 may include a linear or a switching voltage regulator that controls the output voltage for a range of output currents to said nominal output voltage. In this case, the nominal output voltage is to be seen as a target voltage to which the output power regulator 40 aims to control the actual output voltage V4. In practice, the actual output voltage V4 will always show some deviation from that target in the form of the nominal output voltage due to the responsiveness of the control loop, the involved elements (like transistors, linear elements, switching elements, inductors, capacitors, controllers, etc.), and, of course, also variations in the load.

According to this embodiment, the output power regulator 40 is further configured to adjust said nominal output voltage based on an amount of energy stored by said electrical energy storage 20. For this purpose, there may be provided some kind of feedback 2-0 from the electrical energy storage 20 toward the output power regulator 40. Generally, the output power regulator 40 is controlled to adjust the nominal output voltage based on the amount of energy that is stored in electrical energy storage 20, so that at least some indications on the state of stored energy (state of charge, SOC) can be deduced from the regulator's output voltage.

FIGS. 2A through 2D show exemplary details of how the output power regulator 40 can be controlled to adjust the nominal output voltage based on the amount of energy that is stored in electrical energy storage 20. The nominal output voltage is assumed to coincide with the actual or a measured output voltage V4 of the output power regulator 40, and the amount of energy that is stored in electrical energy storage 20 is represented as a state of charge (SOC) that is assumed to vary at most between 100% (full or maximum amount of energy is stored) and 0 (empty).

In the embodiment shown in conjunction with FIG. 2A, the output power regulator 40 is controlled to adjust the nominal output voltage so as to be at a first target voltage V4a as long as the amount of energy SOC that is stored in electrical energy storage 20 is above or equal to a threshold state of charge SOCc. As soon as the amount of energy SOC that is stored in electrical energy storage 20 falls below (or is equal to) that threshold state of charge SOCc, the power regulator 40 is controlled to adjust the nominal output voltage to decrease to be at a lower second target voltage V4b. The difference between V4a and V4b can be identified as a predetermined output voltage drop, that can be set to an appropriate value.

For example, it can be set to a value of approximately 0.1 volts, when the otherwise existent voltage variation of the output power regulator 40 for the expected range of likely loads of the local consumer load is sufficiently below that, i.e. that it can be reliably distinguished from a voltage drop that is not caused by the controlled decrease but by normal variations. Generally, the predetermined output voltage drop can be set to a value that is distinguishable at the site of the local consumer load but will, if applied, still allow that local consumer load to operate properly. For example, the local consumer load may operate in a voltage range of 4.5 Volts to 5.5 Volts, and the target nominal voltage V4a can be set to 5.0 Volts so that above SOCc the local consumer load will be provided with 5.0 Volts and below SOCc the output voltage would fall to 4.9 Volts, which can be well noticed by the local consumer load and still allows reliable operation within the given specifications. Other preferably values for the predetermined output voltage drop can be 0.5 Volts and 1.0 Volt for nominal output voltages in the order of the range of 3.0 Volts to 12 Volts, for example.

In the embodiment shown in conjunction with FIG. 2B, the output power regulator 40 is controlled to adjust the nominal output voltage so as to be at a first target voltage V4a as long as the amount of energy SOC that is stored in electrical energy storage 20 is above or equal to a threshold state of charge SOCc. As soon as the amount of energy SOC falls below (or is equal to) SOCc, the power regulator 40 is controlled to adjust the nominal output voltage to decrease to be at a lower second target voltage V4b. When the amount of energy SOC falls even below (or is equal to) the further threshold SOCcc, the power regulator 40 is controlled to adjust the nominal output voltage to decrease even more to be at an even lower third target voltage V4c. In this way, the local consumer load can be notified of an imminent exhaustion of the electrical energy storage 20 and by low voltage V4c even forced to reduce power consumption and/or to switch to a power save, off, or idle mode.

In the embodiment shown in conjunction with FIG. 2C, the output power regulator 40 is controlled to adjust the nominal output voltage so as to linearly follow the amount of energy SOC that is stored in electrical energy storage 20 as long it is above or equal to a threshold state of charge SOCc. As soon as the amount of energy SOC falls below (or is equal to) SOCc, the power regulator 40 is controlled to adjust the nominal output voltage to decreased but fixed second target voltage V4b. In this way, the local consumer load can be notified continuously of the SOC but a minimum output voltage V4b is maintained as long as possible to allow for a reliable operation of the local consumer load. In the embodiment shown in conjunction with FIG. 2D, the voltage V4a is maintained as long SOC is above SOCc and kept at the decreased voltage V4b for a SOC below SOCc′. There in between there can be a linear regimen, in which the nominal output voltage reflects the SOC. It is noted that combinations of the above are envisaged but not detailed explicitly for the sake of brevity.

Generally, it is noted that the employed electrical energy storage 20 can express various behaviors of the electrical energy storage voltage in relation to the amount stored. In the case of batteries, the dependency is usually not linear, and the battery provides a more or less constant output voltage. Once, however, the SOC decreases the output voltage will decrease at a faster and faster rate. In other cases, including for example capacitive energy storages, the electrical energy storage voltage may closely follow the SOC, in some ranges even approximately linear. Yet still, the electrical energy storage in such cases provides the second electrical power at an energy storage voltage V2 which changes at least in relation to some amounts of energy stored. In principle, the output power regulator 40 can thus be configured to determine an amount of energy stored by the electrical energy storage 20 based on the energy storage voltage V2.

For providing this feedback (as shown in FIG. 1A with 2-0) there may be thus a voltage sensing line that allows the power regulator 40, or a controller therefor, to measure the voltage of the electrical energy storage 20 so as to determine an amount of stored energy. If, for example, that measured voltage falls below a given threshold that may indicate that the SOC runs empty (e.g. in turn falls below a respective threshold, SOCc, SOCcc, SOCc′, etc.), the nominal output voltage may be decreased accordingly so as to notify the local consumer load. The feedback 2-0 may well be provided in an alternative manner, including one or more digital signal line(s) that convey information of the SOC with a relatively low complexity, i.e. a high level “1” indicates “full”, and a low level “0” indicates that the electrical energy storage runs empty, or with a relatively high complexity involving a plurality of digital signals. In the latter case, a protocolled data message may be provided via interfaces like 1Wire, I2C, SPI and the like. As such IC to IC interfaces are widely used they may offer a convenient way to implement the feedback 2-0.

FIG. 1B shows a schematic view of a power supply unit according to a general embodiment, with some but yet still exemplary forms of the respective elements. The power supply unit 101 is for a local consumer load and implemented as a compact device in a housing 52. The power supply unit 101 includes an electrical power generating device 11 configured to generate power from the environment and to provide first electrical power in the form of, for example, a solar cell. An electrical energy storage 21 is configured to store electrical energy and to provide second electrical power and can be provided for example in the form of a battery. An electric buffer 31 is configured to receive and to buffer said first and said second electric power, and to provide a buffer output power, and can be implemented as a high-capacity capacitor (supercap, ultracap, etc.).

The power supply unit 101 further includes an output power regulator 41 that is configured to provide an output power at a nominal output voltage from said buffer output power, and to adjust said nominal output voltage based on an amount of energy stored by said electrical energy storage 21. The power supply unit 101 includes a connector 410 through which the output power may be accessed and provided to a local consumer load via an appropriate connection (e.g. plug and cable). In the housing 52 there may be provided a printed circuit board (PCB) 51 for holding and connecting at least some components, such as the electric buffer 31, the electrical energy storage 21, and the output power regulator 41.

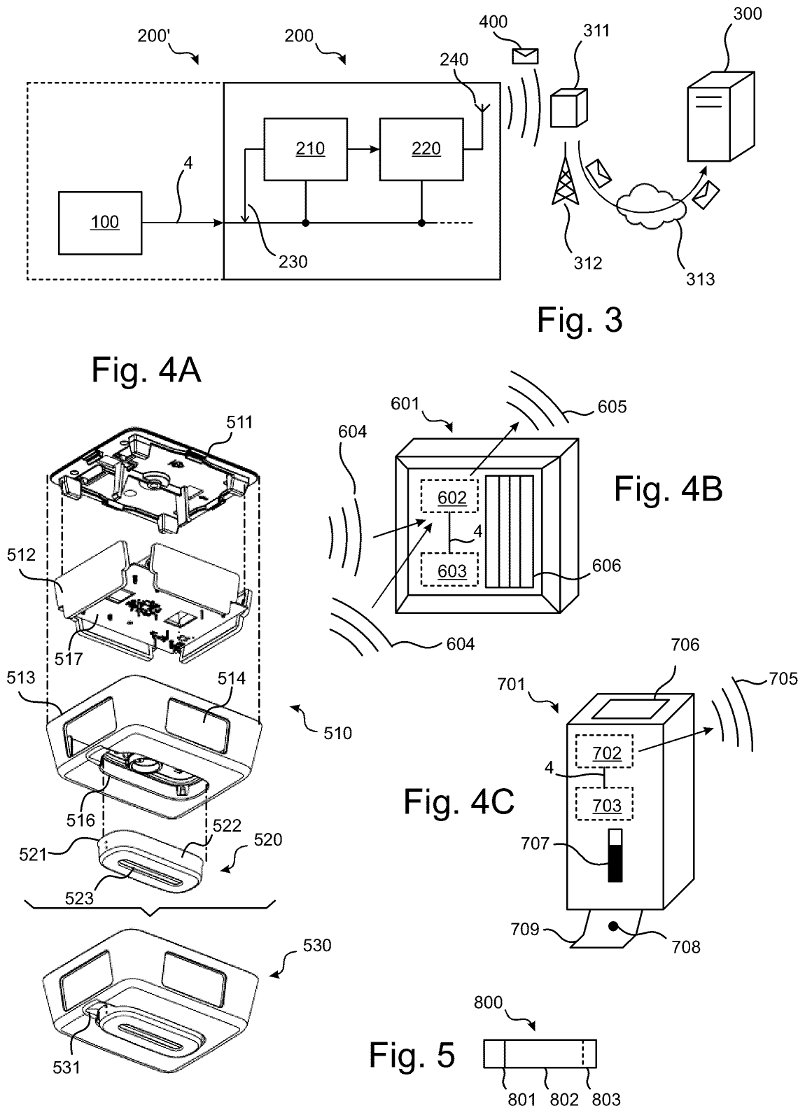

FIG. 3 shows a schematic view of a load device to be supplied by power according to an embodiment. Specifically, there is shown a load device 200 that is configured to report acquired data toward a data processor 300. The load device 200 includes a processing unit 210 that is configured to compile a report message 400 in relation to data acquired by means, for example, measuring an internal or external observable by appropriate sensor elements and equipment (to be detailed further below). The load device 200 is adapted to be supplied with output power 4 provided by a power supply unit according to any appropriate embodiment as described elsewhere in the present disclosure.

Specifically, the load device 200 may include a connector or slot so as to be connected to a power supply unit 100 or to accommodate and/or also engage mechanically with a power supply unit 100. In further embodiments, the load device includes a respective power supply unit 100 in a more or less integrated fashion (denoted with reference numeral 200′). So, generally, the load device 200 and the power supply unit 100 may be individual parts, being possible separated or separatable in space, but connected by a cable for transferring power. In this option, each unit can be placed at a most suitable location (e.g. the power supply concealed underneath a ceiling and a sensor device on the ceiling so as to range into the room of interest). Likewise, the two parts may be still individual and separable, but form one unit in a connected state (e.g. two parts with fitting housings that may not only engage electrically over the connector, but also mechanically by means of suitable interaction). Yet further, the two parts can be integrated in one device, see 200′.

The load device 200 further includes a transmission unit 220 that is configured to transmit said compiled message 400 toward the data processor 300. The latter transmission may be performed by means, for example, translating the information content of the message 400 into an appropriate sequence of electromagnetic pulses or waveforms to be transmitted by an antenna 240 so as to convey the message 400 toward receiving equipment such as a wireless access point 311 (e.g. WLAN, WiFi, Bluetooth, and the like) and/or to a bases station 312 of a mobile communication network (e.g. 2G, 3G, 4G, 5G, LTE, UMTS, GSM, GPRS, PCS, and the like). The message 400 may be forwarded by a communication network, network backbone, or the Internet 313 toward the data processor 300, which may be as such again a cloud or network entity or a dedicated set of processing equipment, for example in the form of a computer or server 300.

According to present embodiments, the load device 200 includes a processing unit 210 that is configured to compile said message 400 further based on the voltage of said output power 4. Basically, the provided power 4 may feed the components—or all components—of the load device 200, such as the processing unit 210, the transmission unit 220, and/or further sensor and functional units and elements.

In one embodiment, the processing unit can be connected to a feedback line 230 and in this way configured to measure a value of the voltage of said output power 4 enabling the processing unit 210 to obtain a value which is related to the voltage that is supplied by the power supply unit 100 and in this way receive the information from that power supply unit 100 which relates to a storage state (amount) of the electrical energy storage as part of the power supply 100. In this embodiment, the processing unit 210 is further configured to compile the message 400 based on a result of said measuring the voltage of said output power 4, for example by coding and/or considering the mentioned voltage value in the message content of the message 400 (see details described in conjunction with FIG. 5).

FIG. 4A shows a schematic view of a load devices in the specific form of a sensor device according to the respective embodiments. Specifically, there is shown a combinable configuration 530 of a power supply unit in the form of a power supply device 510 and a load device 510 in the form of a sensor device (e.g. a thermopile proximity/presence senor). Generally though, the load device 520 includes a sensor unit configured to sense an observable and to provide an output signal in relation to said observable. The processing unit can then be configured to compile the report message further based on the output signal in relation to said observable. The sensor unit can be configured to sense an observable that is related to any one of a presence of an individual, a passing of an individual, a proximity of an individual, a use of hygiene equipment, a level of a consumable in a dispenser, a level of air quality, a presence or concentration of odor agents, a presence or concentration of carbon dioxide and/or monoxide, and/or presence or concentration of a volatile organic compound.

In a specific embodiment, the sensor unit 523 is configured to sense an observable that is related to any one of a presence of an individual, a passing of an individual and/or proximity of an individual, and includes a temperature and/or radiation sensitive sensor, preferably a thermopile. Said sensor unit 523 can be arranged toward an exterior of the device 520 so as to have access to a sensing range. In the shown example, the sensor device 520 includes a housing 522 which features an engagement part 521 that can engage with or in a respective bay 516 of the power supply device 510 for establishing mechanical fixing and electrical connection. In an assembled state shown as 530, an opening or recess 531 may provide access to an actuator that ran release the sensor device 520 from the power supply device 510. The latter power supply device 510 can be for example mounted to a wall or ceiling with its base 511 which then allows the sensor unit 520 to detect presence in the respectively accessible volume range.

The overall configuration as well as the power supply device 510 are shown in an exploded view in the upper part of the Figure. This allows also visualization of internal components, such as a printed circuit board (PCB) 517 for holding and connecting any one of said electrical power generating device, electrical energy storage, electric buffer, output power regulator, processing unit, and transmission unit. For example, on the PCB 517 there may be battery holders arranged to hold one or more replaceable batteries (e.g. of a standard AA or AAA type) that can be replaced easily when depleted (as notified by means of the embodiments). For example, battery replacement may be effected by removing at least the cover 513. The electrical power generating device includes in this embodiment a number of light energy harvesting panels (type of solar cell) 512 that can retrieve light through corresponding openings 514 of the cover 513. The cover 513 may be removed and/or a battery may be replaced only after the sensor device 520 has been separated. In this way, the sensor device 520 may be configured to report an opening or replacement attempt immediately or after re-connection.

FIG. 4B shows a schematic view of a load devices in the specific form of a data collection unit (DCU) that can be in wireless communication with one or more data acquisition units and is configured to collect data from the one or more data acquisition units, such as the sensor 520/530 described in conjunction with the preceding FIG. 4A. Specifically, the load device 601 can be in the form of such a DCU and accordingly includes a data collection and forwarding unit 602 configured to receive a plurality of message signals 604, process said message signals 604, compile an outbound message 605 based on said processed message signals 604, and to transmit said outbound message 605. Optionally, the data collection and forwarding unit 602 can be further configured to buffer any received signals, messages and data so as to provide a consolidated, compressed, or simplified outbound message 605. Generally, such data collection unit (DCU) may find their applications in collecting data from a plurality of sensors and other data sources in the context of distributed data acquisition equipment and/or the Internet of things (IoT) and to forward this toward the cloud, or generally a communication network, for storage and processing by a processing entity.

According to the present embodiment, the data collection unit (DCU) 601 as a form of a load device includes a power supply device 603 according to any applicable embodiment. In this way, the internal power supply can employ the communication capabilities of the data collection and forwarding functionalities so as to convey information toward the network that indicates an energy storage state of an electrical energy storage. For example, the power supply unit may include electrical power generating device in the form of a solar or light panel 605 which is supposed to harvest energy and store that electric buffer for normal operation of the data collection and forwarding functionalities. For situations in which there is little energy generation (at night or in the dark) and/or situations in which there is increased data traffic (many signals 604 received, many outbound messages 605 to be forwarded and transmitted), the power supply unit 603 may employ its electrical energy storage.

The respective embodiments allow to ensure operation the data collection unit (DCU) 601 also under the above-mentioned circumstances by providing power from the electrical energy storage. However, this electrical energy storage may deplete over time and a respective notification may be provided by setting the voltage of the output power 4 accordingly. The data collection and forwarding functionalities may be employed for generating the outbound message 605 further based on a measurement of that voltage so as to notify toward the network that the electrical energy storage is depleting and may require replacement and/or recharging.

FIG. 4C shows a schematic view of a load device in the specific form of a dispenser for dispensing an amount of a consumable being for example any one of soap, disinfectant, alcogel, and the like substances used in the context of hygiene equipment. As an example, the dispenser is shown as a dispenser 701 for dispensing an amount of a liquid 708 (e.g. soap) upon actuating a lever 709. The description of the dispenser 701 is not to be seen limiting in any way and merely as an example for generally a piece of hygiene equipment. In the context of a dispenser, there may, however, be provided a reservoir 707 which can be internal or external and which can be replaceable or refillable.

The load device in the form of dispenser 701 further includes a sensor unit 702 for measuring and reporting a filling state of a reservoir 707 of said consumable. Specifically, there may be provided a capacitive, optical or mere contact sensor that can detect a filling state of the reservoir at a more or less fine degree. For example, the sensor may provide an accurate value at a relatively high and fine resolution, e.g. from 0% to 100% in steps of 1%, or, on the other end of the spectrum, only an indication “ok” or “not ok”, wherein the latter may indicate that the reservoir is empty, may run empty soon and/or has fallen below a certain threshold, or—generally—a replacement or refill is needed or recommended. The sensor unit 702 may be further configured to report the information on the measured filling state toward a processing entity located or connected to the cloud or any other communication network infrastructure by means of a message 705.

According to the present embodiment, the dispenser 701 as a form of a load device includes a power supply device 703 according to any applicable embodiment. In this way, the internal power supply can employ the communication capabilities and the functionalities of the sensor unit 703 so as to convey information toward the network that indicates an energy storage state of an electrical energy storage. For example, the power supply 703 unit may include electrical power generating device in the form of a solar or light panel 706 which is supposed to harvest energy and store that electric buffer for normal operation of the data collection and forwarding functionalities. For situations in which there is little energy generation (at night or in the dark) and/or situations in which there is increased use, e.g. many dispensing events that may result in a relatively higher energy consumption of the sensor unit or any other part of the dispenser fed by the power supply device 703, the power supply unit 703 may employ its electrical energy storage.

The respective embodiments allow to ensure operation of the dispenser 701 also under the above-mentioned circumstances by providing power from the electrical energy storage. However, this electrical energy storage may deplete over time and a respective notification may be provided by setting the voltage of the output power 4 accordingly. The reporting functionalities may be employed for generating the outbound message 705 further based on a measurement of that voltage so as to notify toward the network that the electrical energy storage is depleting and may require replacement and/or recharging.

A general objective may be presented at this point insofar the power consumption of any load device may vary in relation to some unpredictable factors or factors that are difficult to predict. For example, a sensor device may consume more power if there are more events to detect, a thermopile sensor may consume power if there are many individuals passing, or a DCU may consume more power if there is more data to collect and forward. While the power supply unit provides means for generating (harvesting) energy and buffering this energy for operation under normal conditions, the storage may step in once more power is consumed. However, it can be sometimes difficult to predict when such storage depletes and needs replacement. To be on a safe side, operators may thus choose a shorter replacement cycle for ensuring reliability—which leads in possible waste of resources as storages are replaced or accessed although not yet depleted—or accept situations in which the storage is depleted—accepting in turn the failure of a reporting, forwarding or other functionality in the field. Embodiments may provide the advantage that a depleting storage can be reported to an operator so that only the depleting or depleted storages are replaced.

FIG. 5 shows a schematic view of a message configuration according to an embodiment. Specifically, a message 800 may be in the form of a frame including one or more subframes or subsections as this would be appropriate for and compatible to the used communication protocol. The message 800 may include a header 801 including for example identification information indicating a message originator and/or a message recipient. This usually allows proper routing in the employed communication network and proper allocation. For example, header 801 may include information that can be used to identify a specific dispenser or DCU and/or a specific processing entity on the other side of the network as the recipient (for example, a server which has interest in receiving the forwarded/reported data).

In a payload section 802 any suitable payload data may be carried or coded (e.g. the information that a dispenser requires a refill). The message 800 may further include an indicator 803 as an explicit part or as part of the payload data 802. Specifically, the indicator 803 can be added to or inserted into the message 800 based on the voltage of said output power of a power supply unit as described in conjunction with the present disclosure. This functionality may be implemented by any suitable component such as the processing unit that is responsible for compiling the message. That processing unit can be further configured to add the indicator to the message if a value as a result of measuring the voltage of the output power 4 is below a predetermined threshold value.

Although detailed embodiments have been described, these only serve to provide a better understanding of the invention defined by the independent claims and are not to be seen as limiting.

1. A power supply unit for a local consumer load comprising:
an electrical power generating device configured to generate power from the environment and to provide first electrical power;
an electrical energy storage configured to store electrical energy and to provide second electrical power;
an electric buffer configured to receive and to buffer said first and said second electric power, and to provide a buffer output power; and
an output power regulator configured to provide an output power at a nominal output voltage from said buffer output power, and to adjust said nominal output voltage based on an amount of energy stored by said electrical energy storage.

2. The power supply unit according to claim 1, wherein said output power regulator is configured to decrease said nominal output voltage by a predetermined output voltage drop when the stored amount of energy falls below a predetermined threshold.

3. The power supply unit according to claim 1, wherein said electrical energy storage is configured to provide said second electrical power at an energy storage voltage which changes at least in relation to some amounts of energy stored.

4. The power supply unit according to claim 3, wherein said output power regulator is configured to determine an amount of energy stored by said electrical energy storage based on said energy storage voltage.

5. The power supply unit according to claim 1, wherein said power generating device comprises any one of an energy harvesting element, a solar cell, a solar panel, a thermal energy cell, and a radio wave harvester.

6. The power supply unit according to claim 1, wherein said electrical energy storage comprises any one of a battery, a rechargeable battery, and a super capacitor.

7. The power supply unit according to claim 1, wherein said electricity buffer comprises any one of an electrolytic capacitor, a tantalum capacitor, a high-capacity capacitor, a rechargeable battery, a super capacitor, and an ultracap.

8. A load device configured to report acquired data toward a data processor, comprising a processing unit configured to compile a report message in relation to said acquired data, and a transmission unit configured to transmit said compiled message toward said data processor,
said load device being adapted to be supplied with said output power provided by a power supply unit according to claim 1,
wherein said processing unit is configured to compile said message further based on the voltage of said output power.

9. The load device according to claim 8, wherein the processing unit is configured to measure a value of the voltage of said output power and to compile the message based on a result of said measuring the voltage of said output power.

10. The load device according to claim 9, wherein the processing unit is configured to add an indicator to said message based on the voltage of said output power.

11. The load device according to claim 9, wherein the processing unit is configured to add an indicator to said message if a value as a result of said measuring the voltage is below a predetermined threshold value.

12. The load device according to claim 8, further comprising a sensor unit configured to sense an observable and to provide an output signal in relation to said observable, said processing unit being configured to compile the report message further based on the output signal in relation to said observable.

13. The load device according to claim 12, wherein said sensor unit is configured to sense an observable that is related to any one of a presence of an individual, a passing of an individual, a proximity of an individual, a use of hygiene equipment, a level of a consumable in a dispenser, a level of air quality, a presence or concentration of odor agents, a presence or concentration of carbon dioxide and/or monoxide, and/or presence or concentration of a volatile organic compound.

14. The load device according to claim 13, wherein said sensor unit is configured to sense an observable that is related to any one of a presence of an individual, a passing of an individual and/or proximity of an individual, and comprises a temperature and/or radiation sensitive sensor, preferably a thermopile.

15. The load device according to claim 8, further comprising a data collection and forwarding unit configured to receive a plurality of message signals, process said message signals, compile an outbound message based on said processed message signals, and to transmit said outbound message.

16. The load device according to claim 8, further comprising a dispensing assembly for dispensing an amount of a consumable and a sensor unit for measuring and reporting a filling state of a reservoir of said consumable.

17. The load device according to claim 8, further comprising a power supply unit including:
an electrical power generating device configured to generate power from the environment and to provide first electrical power;
an electrical energy storage configured to store electrical energy and to provide second electrical power;
an electric buffer configured to receive and to buffer said first and said second electric power, and to provide a buffer output power; and
an output power regulator configured to provide an output power at a nominal output voltage from said buffer output power, and to adjust said nominal output voltage based on an amount of energy stored by said electrical energy storage.
